(19) United States
(12) Patent Application Publication
(10) Pub. No.: US 2021/0041915 A1
(43) Pub. Date: Feb. 11, 2021

(54) Smart Multi-Display Laptop

(71) Applicant: MLY Technix Corp., Santa Clara, CA (US)

(72) Inventor: George MOSER, Santa Clara, CA (US)

(21) Appl. No.: 16/862,275

(22) Filed: Apr. 29, 2020

Related U.S. Application Data
(60) Provisional application No. 62/922,319, filed on Aug. 5, 2019.

(51) Int. Cl. G06F 1/16

(52) U.S. Cl. CPC G06F 1/1649; G06F 1/1605; G06F 1/1607

(57) ABSTRACT

A multi-display panel laptop computer comprising a bay in the laptop base for receiving and holding a smart device, such as a tablet or a smart phone, which may be used as a second removable display panel of the laptop computer. The laptop computer may be configured with holding fixtures and connectors so that when the smart device is docked into the laptop computer, the smart device may be automatically charged and synced with the laptop computer, according to user-selectable settings. The laptop computer may makes mobile applications available on the laptop and allows a user to run the mobile applications on the laptop using the laptop keyboard for easier and more accurate input, as well as send output of the mobile applications to the laptop computer's larger display panel, which makes it easier to read.

### CROSS-REFERENCE TO RELATED APPLICATION

This application claims the benefit of, and priority to, U.S. Provisional Patent Application No. 62/922,319, having a filing date of Aug. 5, 2019, entitled “Smart Multi-Display Laptop,” the entire disclosure of which is hereby incorporated herein by reference.

### TECHNICAL FIELD

The present invention relates in general to the computer field, and, in particular, to portable computer hardware and software.

### SUMMARY

In one embodiment, a multi-display panel laptop computer comprises: a first display unit configured to be rotatably attached to a laptop base of the laptop computer through a connector located substantially near a front end of the laptop base, wherein the connector is configured to adjust a viewing angle of the first display unit; and a second detachable display unit configured to be: mounted in the laptop base in a first state, removed from the laptop computer in a second state, and re-inserted into the laptop base in the first state. See, e.g., FIG. 4.

In some embodiments, a user-deployable incline mechanism is configured to tilt the laptop base and thus adjust a viewing angle of at least the second detachable display unit. See, e.g., FIGS. 6-7.

In some embodiments, the second detachable display unit is configured to: be mounted on a movable structure on the laptop base that holds the second detachable display unit, and permit adjustment of a viewing angle for at least the second detachable display unit. See, e.g., FIGS. 8-9.

In some embodiments, the second detachable display unit is a smart display unit that includes a CPU, memory and storage.

In some embodiments, the second detachable display unit is a tablet computer. See, e.g., FIGS. 10-11.

In some embodiments, the laptop computer and the tablet computer comprise a holding mechanism and mating connectors that hold the tablet computer and establish communication between the laptop computer and the tablet computer upon insertion of the tablet computer into the laptop computer, thereby configuring the laptop computer to charge the tablet computer and to sync data between the laptop computer and the tablet computer according to user-selectable settings. See, e.g., FIG. 10.

In some embodiments, a user-deployable incline mechanism is configured to tilt the laptop base to adjust a viewing angle of the tablet computer.

In some embodiments, the tablet computer is configured to be mounted on a pivotable carrier structure on the laptop computer configured to rotate the tablet computer about the laptop computer to adjust the viewing angle of the tablet computer.

In some embodiments, the second detachable display unit is a smart phone. See, e.g., FIGS. 18-19.

In some embodiments, the laptop computer is configured to dock, hold, communicate and collaborate with a tablet computer and/or a smart phone. See, e.g., FIGS. 20-21.

In some embodiments, the second detachable display unit is a full-size tablet computer having a cross-sectional area corresponding with all, substantially all or most of a cross-sectional area of the laptop base. See, e.g., FIGS. 23-24.

In some embodiments, the full-size tablet computer is configured to adjust an angular position of the tablet computer. See, e.g., FIGS. 25-26.

In some embodiments, the tablet computer comprises docking and holding features, power and data connectors and computer-implemented instructions, thereby configuring the tablet computer to be used as an additional display of the multi-display panel laptop computer and configured to sync, charge and collaborate with the laptop computer.

In some embodiments, the smart phone comprises docking and holding features, power and data connectors and computer-implemented instructions, thereby configuring the smart phone to be used as an additional display of the multi-display panel laptop computer and configured to sync, charge and collaborate with the laptop computer.

In some embodiments, the tablet computer is configured to: be compatible with multiple Operating Systems, and dock, interface, communicate, sync and collaborate with the multi-display panel laptop computer, wherein the multi-display panel laptop computer is configured to include one or more Operating Systems from the group consisting of Microsoft Windows, Apple macOS, Linux, Apple iOS, and Android.

In some embodiments, the smart phone is configured to: be compatible with multiple Operating Systems, and dock, interface, communicate, sync and collaborate with the multi-display panel laptop computer, wherein the multi-display panel laptop computer is configured to include one or more Operating Systems from the group consisting of Microsoft Windows, Apple macOS, Linux, Apple iOS, and Android.

In some embodiments, the multi-display panel laptop computer is configured to: be compatible with multiple Operating Systems, and dock, interface, communicate, sync and collaborate with one or more portable devices from the group consisting of a tablet computer and a smart phone, wherein the one or more portable devices is configured to include one or more Operating Systems from the group consisting of Microsoft Windows, Apple macOS, Linux, Apple iOS, Android and others.

### BRIEF DESCRIPTION OF THE DRAWINGS

The accompanying drawings, which are incorporated into this specification, illustrate one or more exemplary embodiments of the inventions disclosed herein and, together with the detailed description, serve to explain the principles and exemplary implementations of these inventions. One of skill in the art will understand that the drawings are illustrative only, and that what is depicted therein may be adapted based on the text of the specification and the spirit and scope of the teachings herein.

In the drawings, in which non-limiting examples are illustrated, where like reference numerals refer to like reference in the specification:

FIG. 1 shows a prior art conventional laptop computer.

FIG. 2 shows a prior art multi-display laptop computer.

FIG. 3 shows a prior art multi-display laptop computer with adjustable secondary display panel.

FIG. 4 shows an embodiment of the invention with a removable second display in a second, removed state.

FIG. 5 shows the removable second display panel inserted into the laptop base in a first state.

FIG. 6 shows an incline mechanism for a multi-display panel laptop with removable second display.

FIG. 7A shows a cross-section of the incline mechanism of FIG. 6

FIG. 7B shows a different embodiment of an incline mechanism for a multidisplay laptop.

FIG. 8 shows a multi-display laptop with a position-adjustable removable second display.

FIG. 9 shows the embodiment of FIG. 8 with the position-adjustable removable display inserted into the laptop.

FIG. 10 shows another embodiment of the invention wherein the second display is a smart removable device such as a tablet computer.

FIG. 11A shows the embodiment of FIG. 10 with the smart removable device inserted into the laptop as a second display.

FIG. 11B is a schematic block diagram of the laptop computer arrangement of FIGS. 10 and 11A.

FIG. 12 shows the embodiment of FIG. 10 with an incline mechanism that enhances viewing of the smart removable device.

FIG. 13 shows a cross-section of FIG. 12.

FIG. 14 shows an embodiment of the invention with a removable smart device, which is also position-adjustable with a rotatable shell for enhanced image quality.

FIG. 15 shows the embodiment of FIG. 14 with the smart device housed in the shell.

FIG. 16 shows the embodiment of FIG. 14 with an additional incline mechanism to enhance the viewing of the smart device.

FIG. 17 is a cross-section of FIG. 16.

FIG. 18 shows an embodiment of the invention where the removable smart device supported is a smart phone.

FIG. 19 shows the embodiment of FIG. 18 with the smart phone docked into and interfaced with the laptop.

FIG. 20 shows an embodiment of the invention that supports both a tablet and a smart phone as removable smart devices.

FIG. 21 shows the embodiment of FIG. 20 with the tablet and the smart phone docked into and interfaced with the laptop.

FIG. 22 shows another embodiment with a full-size removable display as a secondary display panel.

FIG. 23 shows the embodiment of FIG. 22 wherein the full-size removable display is a full-size tablet computer.

FIG. 24 shows the embodiment of FIG. 22 with the full-size removable tablet inserted into the laptop.

FIG. 25 shows an embodiment of the invention with a full-size tablet as a second display, which is mounted on a movable structure to provide position-adjustability for viewing quality enhancement.

FIG. 26 shows a support structure to stabilize the full-size tablet used as a second display.

### DETAILED DESCRIPTION

There is an increasing need in the portable computer industry to increase the available display area in laptop computers to provide higher productivity, better functionality and a superior user experience, which may be achieved with multiple displays. The present invention discloses significant improvements in both hardware and software for a new generation of multi-display laptop computers.

It should be understood that this invention is not limited to the particular methodology, protocols, etc., described herein and as such may vary. The terminology used herein is for the purpose of describing particular embodiments only and is not intended to limit the scope of the present invention, which is defined solely by the claims.

As used herein and in the claims, the singular forms include the plural reference and vice versa unless the context clearly indicates otherwise. Other than in the operating examples, or where otherwise indicated, all numbers expressing quantities used herein should be understood as modified in all instances by the term “about.”

All publications (including published patents) identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Unless defined otherwise, all technical and scientific terms used herein have the same meaning as those commonly understood to one of ordinary skill in the art to which this invention pertains. Although any known methods, devices, and materials may be used in the practice or testing of the invention, the methods, devices, and materials in this regard are described herein.

### Some Selected Definitions

Unless stated otherwise, or implicit from context, the following terms and phrases include the meanings provided below. Unless explicitly stated otherwise, or apparent from context, the terms and phrases below do not exclude the meaning that the term or phrase has acquired in the art to which the term or phrase pertains. The definitions are provided to aid in describing particular embodiments of the aspects described herein, and are not intended to limit the claimed invention, because the scope of the invention is limited only by the claims. Further, unless otherwise required by context, singular terms shall include pluralities and plural terms shall include the singular.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

Other than in the operating examples, or where otherwise indicated, all numbers expressing quantities used herein should be understood as modified in all instances by the term “about.” The term “about” when used in connection with percentages may mean±1%.

In embodiments of the disclosure, terms such as “about,” “approximately,” and “substantially” may include traditional rounding according to significant figures of the numerical value.

The singular terms “a,” “an,” and “the” include plural referents unless context clearly indicates otherwise. Similarly, the word “or” is intended to include “and” unless the context clearly indicates otherwise. Thus, for example, references to “the method” includes one or more methods, and/or steps of the type described herein and/or which will become apparent to those persons skilled in the art upon reading this disclosure and so forth.

Although methods and materials similar or equivalent to those described herein may be used in the practice or testing of this disclosure, suitable methods and materials are described below. The term “comprises” means “includes.” The abbreviation, “e.g.”, is derived from the Latin exempli gratia, and is used herein to indicate a non-limiting example. Thus, the abbreviation “e.g.” is synonymous with the term “for example.”

To the extent not already indicated, it will be understood by those of ordinary skill in the art that any one of the various embodiments herein described and illustrated may be further modified to incorporate features shown in any of the other embodiments disclosed herein.

The following examples illustrate some embodiments and aspects of the invention. It will be apparent to those skilled in the relevant art that various modifications, additions, substitutions, and the like may be performed without altering the spirit or scope of the invention, and such modifications and variations are encompassed within the scope of the invention as defined in the claims which follow. The following examples do not in any way limit the invention.

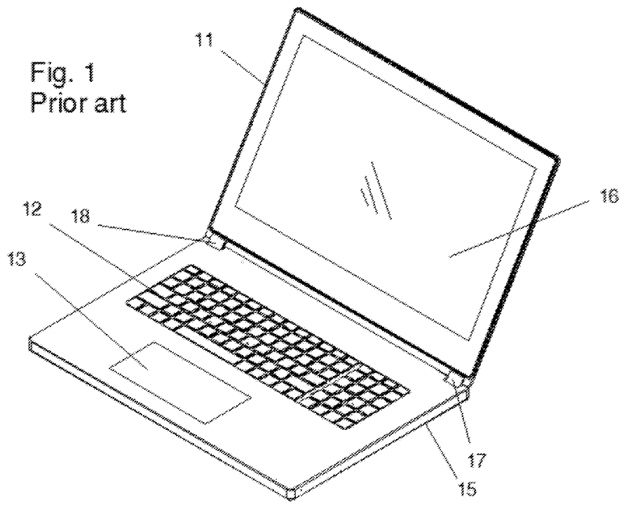

FIG. 1 (Prior art) shows a prior art laptop computer with a single display panel 16. This configuration includes base unit 15 and a display unit 11, which is rotatably connected to the base 15 through hinges 17 and 18. The base unit 15 includes a keyboard 12 and a touchpad 13. The display unit 11 includes a display panel 16, typically an LCD display panel. A limitation of this computer is the limited display area available (only the display panel 16).

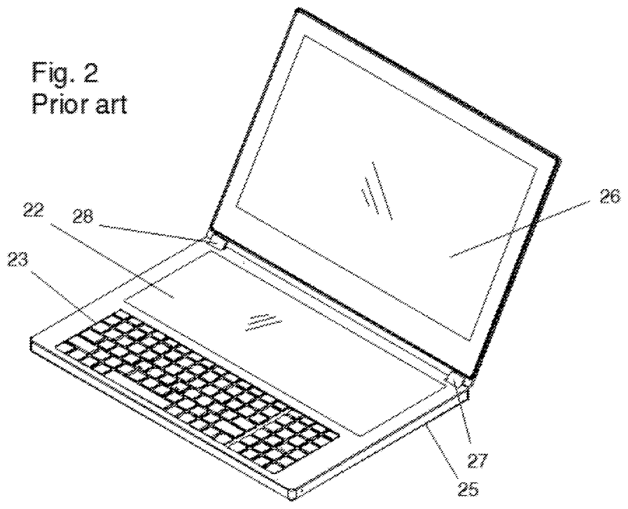

FIG. 2 (Prior art) shows a typical prior art laptop computer with dual display panels 26 and 22, and a keyboard 23. The main display panel 26 is rotatably connected to base unit 25 through hinges 27 and 28. The secondary display panel 22 is mounted inside the base unit 25 in a fixed position. A limitation of this computer is the sub-optimal viewing angle for the secondary display panel 22, since its angular position with respect to the user may not be adjusted, thus providing only limited image quality.

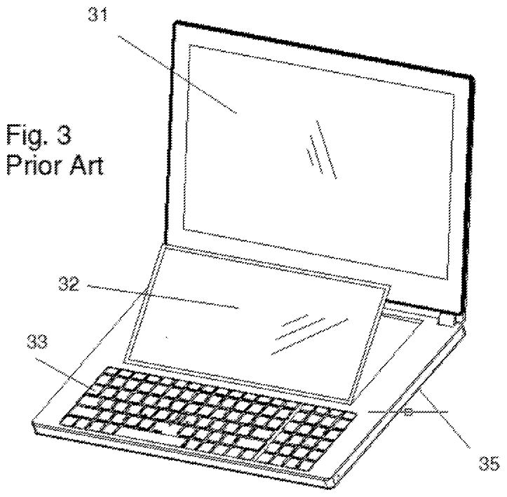

FIG. 3 (Prior art) shows the laptop computer from U.S. Pat. No. 9,501,097 to Moser (“MULTITASKING PORTABLE COMPUTER”), which shows a main display panel 31 and a secondary display panel 32. The secondary display panel 32 is rotatably attached to the base 35 to allow the user to adjust the viewing angle of the secondary display panel 32 (in addition to adjusting the viewing angle of the main display panel 31, which is also rotatably attached to the base 35 through its own hinges). The hinges of the secondary display panel 32 are not visible in FIG. 3 because in the shown embodiment said hinges are inside the base unit 35, not visible to the user. This configuration provides good image quality to the user on both display panels because of the ability to adjust the viewing angle for both display panels.

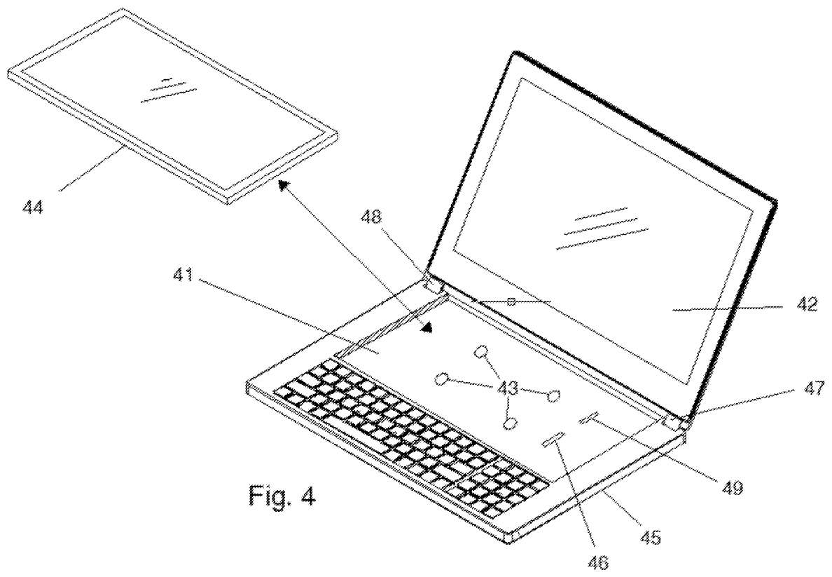

FIG. 4 shows a first embodiment of the present invention, in which the first embodiment comprises a main display unit 42 rotatably attached through connectors (e.g., hinges) 47 and 48 to the laptop base 45; and a second removable display 44 that may be mounted by the user inside a receiving space e.g., a bay 41 in the base 45 (i.e. placed into a first state) for use in the laptop as a second display, or removed by the user from said bay as needed for use in another laptop or in another device such as a gaming platform, or as a presentation display for an audience, amongst many conceivable uses. The second display 44 is a removable display unit that may be equipped with connectors that upon insertion into the bay 41 mate with connectors such as 46 and 49 in the bay to provide power and data connection between the removable display 44 and the laptop. Connector 46 may be a power connector, and connector 49 may be a data connector, including graphical data. Both connectors 46 and 49 may be combined into just one connector. There may be other connectors as well for other purposes such as enhanced connectivity, data storage, enhanced graphics, etc. The term CONNECTORS in this specification includes not only conventional electrical contact connectors but also any other possible type of connectors that can be used to exchange data and/or electrical power, such as contactless connectors, induction devices, infrared ports, optical connectors, wireless sending and receiving devices, and any other devices used to establish communication between the laptop and the removable device 44. Therefore the present invention can be implemented both via physical electrical contact connectors or through wireless or contactless means.

Physically, the removable display 44 may be held in place inside the bay by different methods, such as magnets 43 on the bay side and ferromagnetic parts on the display 44, or vice versa, or magnets with opposite polarity on both display 44 and bay 41.

The removable display unit 44 may be just a display unit, but the preferred embodiment of this invention includes a removable display unit 44 which has been equipped with its own internal electronics (including microprocessor and digital memory) such that it may be used as an independently-operable smart device with its own intelligence and user-interactive computing capabilities, such as a tablet computer (such as for example an Apple iPad or an Android tablet).

The tablet computer 44 could be equipped with the previously described connectors and holding features such as magnets to securely dock into the bay 41. An alternative possible holding feature instead of magnets could be an interlocking spring-loaded mechanism that mechanically engages the removable unit 44 with the bay when the user inserts the removable unit into the bay, and which may be released by the user by pressing a release button or actuating a release slide.

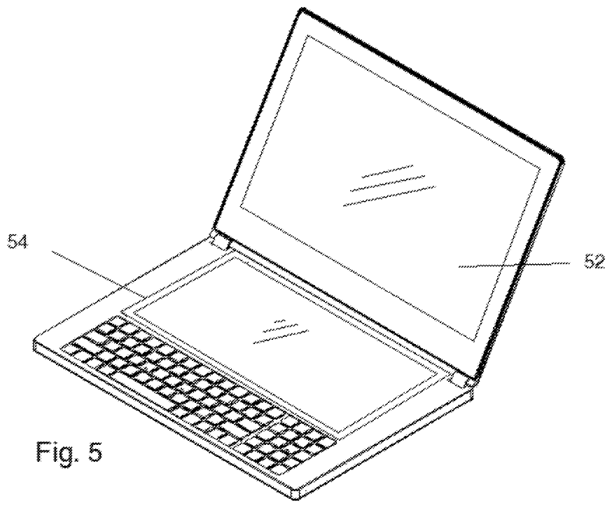

FIG. 5 shows the removable display 54 already inserted into the bay of the laptop computer, ready to be used as a secondary display. In this first embodiment, the secondary display is in a fixed position with respect to the base. Therefore, the user may not adjust the viewing angle for the secondary display 54. Only the main display 52 is position-adjustable.

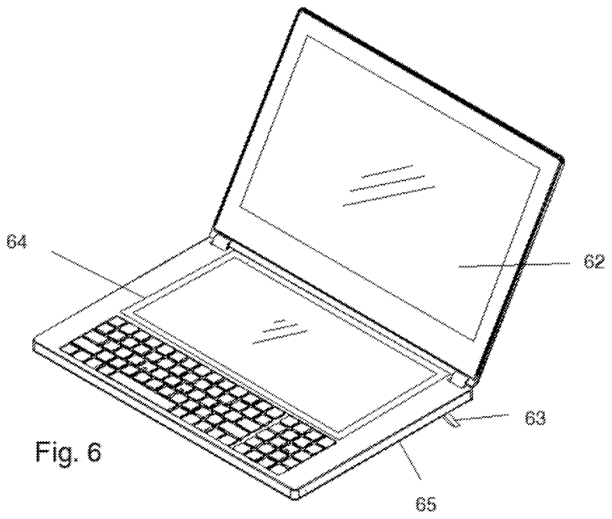

The flat fixed position of the removable display inside the base unit in FIG. 5 may not provide an ideal viewing angle for some users. There are some possible variations to the approach shown in FIG. 5 in order to achieve a better viewing angle. One such possible variation is to provide a support structure on the laptop base that tilts the laptop toward the user to improve the viewing angle, as shown in FIG. 6.

FIG. 6 shows another embodiment of the invention, wherein the limitation of a fixed viewing angle for the secondary removable display panel may be at least partly overcome with a deployable incline mechanism, which consists essentially of a structure (e.g., deployable feet) 63 that may be rotated or extracted out of the laptop base 65 to incline the computer base and therefore achieve a better viewing angle for the secondary removable display panel 62. When the incline mechanism is deployed, the user may adjust the viewing angle for, not one, but both displays, thereby achieving a better image quality on both displays. The incline mechanism may be designed to provide only one fixed incline angle deemed satisfactory to most users, or a choice of multiple incline angles, or even a range of continuously adjustable angles for maximum adjustability. Numerous mechanisms exist in the state of the art of mechanical engineering devices that may provide such features, such as a single stop, multiple stops, ratchet mechanisms, friction hinges with continuous adjustability and others.

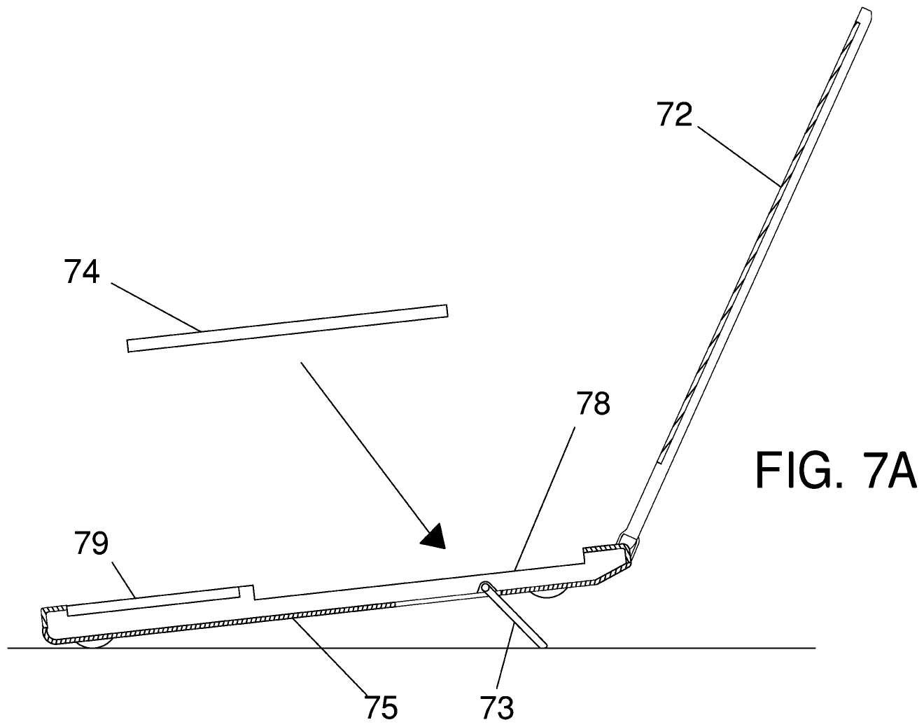

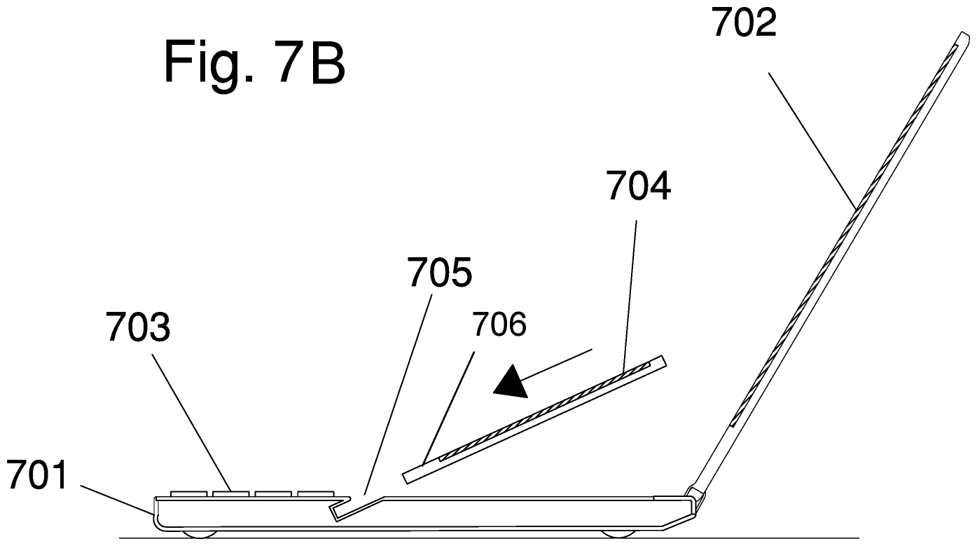

FIG. 7A shows a cross-section view of the same embodiment of FIG. 6. The removable display 74 may be inserted by the user into bay 78. The incline mechanism 73 is attached to the base and may be deployed to tilt the laptop to adjust the viewing angle of secondary display 74 once the secondary display is inserted into the bay 78.

FIG. 7B illustrates another possible mechanism to achieve a better viewing angle for the user (as opposed to just a flat fixed position of the secondary display as shown in FIG. 5). FIG. 7A illustrates a clamshell configuration laptop computer, in a side elevation cross-sectional view. A groove 705 is provided in the laptop base 701, positioned behind keyboard 703. Groove 705 is open to a top surface of laptop base 701, and extends laterally across some or all of the width of laptop base 701. Groove 705 is wide enough to receive within it a lower edge portion 706 of the removable display 704, such that during use, removable display 704 may be propped at an angle (rather than remaining set within a flat receptable). In some embodiments, the groove 705 has a fixed angle with respect to the laptop base 701 (and in particular, an obtuse angle relative to a portion of the top surface of laptop base 701 in which keyboard 703 is set), which imparts a fixed improved viewing angle to the removable display 704, inclined relative to base 701, when removable display 704 is inserted into the groove 705. One or more connectors and/or holding mechanisms (such as magnets or interlocking holding mechanisms on each of removable display 704 and groove 705, not shown in FIG. 7B to avoid complicating and obscuring the drawing) may be located inside the groove 705 (on the bottom of the groove and/or on its sides), positioned to mate with compatible connectors and/or holding mechanisms on the side portion 706 of the removable display 704 when removable display 704 is fully inserted into groove 705. In some embodiments, this approach can be further improved by adding a support structure to tilt laptop base 701 (and in turn, docked removable display 704) toward the user. In some embodiments, a further improvement can be achieved by integrating the groove part into a pivotable hinged receptacle located inside the laptop base, which allows the removable display to be pivoted and rotated along with the receptacle to achieve a desired user-adjustable viewing angle.

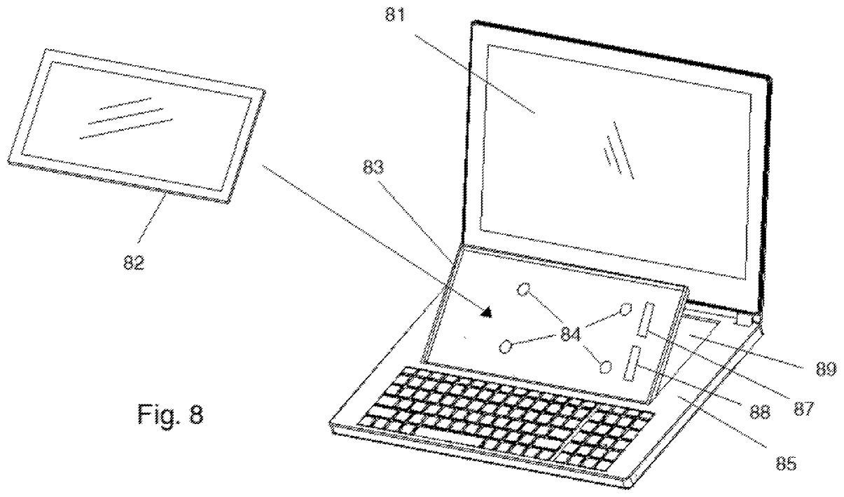

FIG. 8 shows another embodiment of the invention wherein the removable display unit 82 is provided with angular adjustability to enable the user to adjust the viewing angle of the removable second display unit 82. To that effect, a housing (e.g., shell) 83 is rotatably attached to the laptop base 85 through hinges, enabling shell 83 to be adjusted through a range of tile positions, whether parallel with a top surface of laptop base 85, or angled upwards from the top surface of laptop base 85. Said hinges are not visible in FIG. 8 because they are located inside the laptop base 85 (e.g. proximate an edge of shell 83 closest to a user of the computer); of course, it may be simpler but cosmetically less desirable to place the hinges in a visible position outside the laptop base 85. The shell 83 is shown in tilted-up position in FIG. 8, having been rotated up by the user. To close the laptop, the user may push the shell 83 (along with or without the removable display 82) down toward the laptop base 85 until the shell is totally embedded inside the bay 89 completely substantially parallel and flush with the top surface of the laptop base 85.

To use this laptop in dual display panel mode, the user may insert the removable display 82 into the shell 83, which then surrounds the removable display 82 and holds the removable display 82. The shell may be equipped with connectors such as power connector 87 and data connector 88 that mate (or a combined connector for both data and power) with mating connectors on the back of the removable display 82. The removable display 82 may be secured inside the shell 83 by magnets 84 or by a mechanical engagement or interlocking mechanism actionable by the user or by other means. In some embodiments, the engagement or interlocking mechanism(s) may be connectors, such as power and/or data connectors for interaction between the laptop computer base and removable display. An advantage of this embodiment is that the user may insert the removable display into the shell and then adjust the angular position of the shell until a desired viewing angle with optimized image quality for the user is achieved. It is understood that the shell 83 of FIG. 8 is just an illustrative example of how to provide angular adjustability to the removable display; many variations of this approach may be used, such as a partial shell (to save weight), a frame that surrounds the perimeter or a substantial part of the removable display, engagement posts that protrude from the removable display and may be directly inserted into the hinges, and many more, all within the scope of this invention.

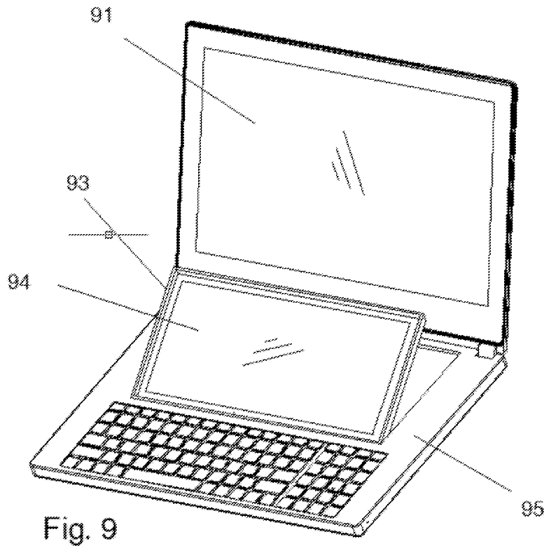

FIG. 9 shows the same embodiment of FIG. 8 with the removable display 94 inserted into the carrier shell 93 and tilted to a user-chosen angle relative to base unit 95.

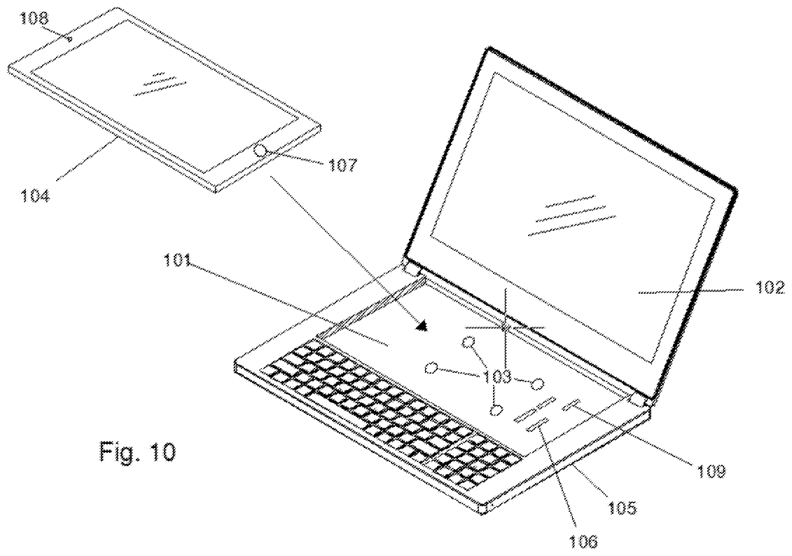

FIG. 10 shows another embodiment of the present invention, wherein the removable display 104 is an independently operable smart computing device, not just a display unit (such as an iPad or an Android tablet or other smart devices). Smart removable display 104 may contain its own CPU, its own digital memory and/or other storage, its own battery, and its own Operating System and Software Applications. This smart removable display 104 may be a complete sophisticated tablet computer with integrated peripherals and user interface components commonly included in tablet computers, such as camera 108 and home button 107, further enabling standalone operation as a mobile computing device.

The laptop of FIG. 10 comprises a main display 102 rotatably attached through hinges to the laptop base 105; and a smart removable display 104 that may be mounted by the user inside a bay 101 in the laptop base 105 for use in the laptop as a second display, or removed by the user from said bay 101 as needed for use as an independently operable tablet computer with portability and convenience in circumstances where the computation and user interface capabilities of the complete laptop are not necessary. The smart removable display 104 may be equipped with connectors that, upon insertion into the bay 101, mate with connectors such as connector 106 and connector 109, which make it possible to automatically recharge the smart removable display 104 and also enable smart removable display 104 to digitally communicate with a CPU resident within the laptop computer (in some embodiments, fully synchronizing its data with the laptop data according to settings previously chosen by the user). Connector 106 may be a power connector, and connector 109 may be a data connection, including graphical data. The tablet computer 104 may be held in place inside the bay by different methods, such as magnets 103 or by other possible mechanisms previously described in this specification.

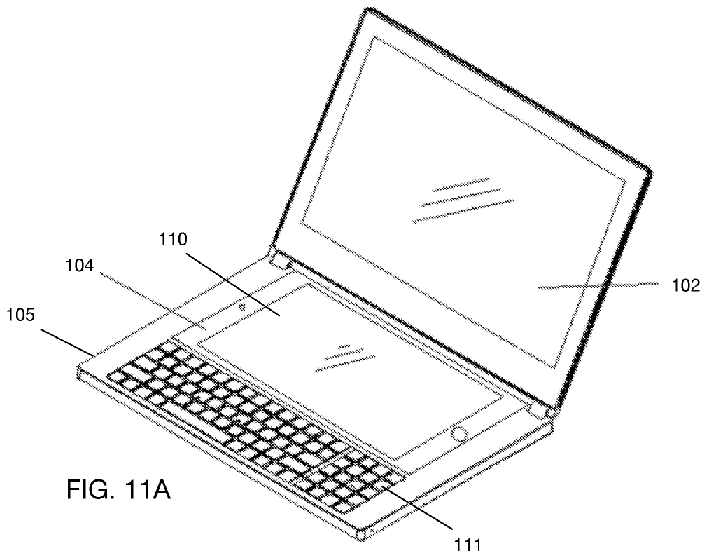

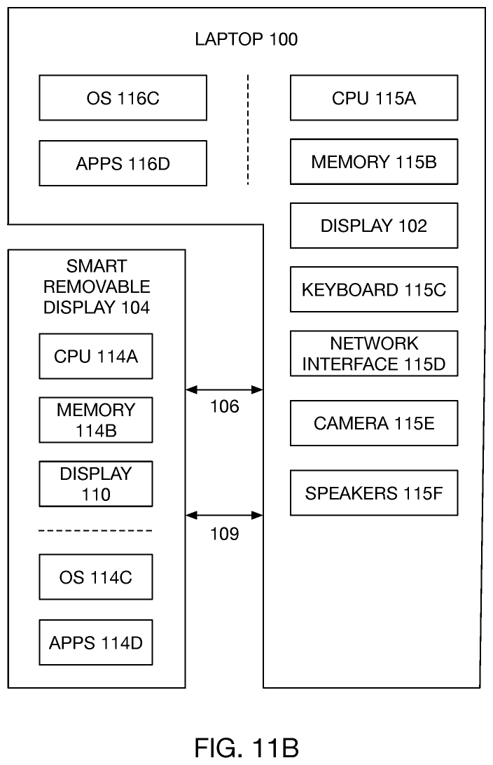

FIG. 11A shows the embodiment of FIG. 10 with the smart removable display 104 already inserted into the laptop base 105, ready to operate as a simple second laptop display panel or as a tablet computer that may interact with the laptop, allowing the user to combine the powerful capabilities of both computers into higher computing power, sharing applications, and collaborating with each other for a substantially enhanced user experience. The video and/or audio output of the tablet computer may be routed to its own display panel 110 or to the main display panel 102 (e.g. via data connector 109) or to both display panels 110 and 102. Similarly, video output of an operating system implemented by a laptop CPU may be routed to its own display panel 102 or to the tablet's display panel 110 (or both). Applications that work best in a mobile environment such as a tablet may be run on the tablet 104, while other applications that work best on a laptop may be run using the laptop display 102 and the laptop computing platform (such as processor, memory and the like). Computational results generated by the tablet may be made available to the laptop, and computational results of the laptop may be made available to the tablet. This new configuration creates a new environment that merges both mobile and laptop computing into one platform, while preserving the ability to remove the tablet for maximum portability whenever it makes sense for the user. An additional advantage is the use of the keyboard 111 for tablet applications, providing faster and more accurate typing input.

FIG. 11B illustrates an exemplary schematic block diagram of certain hardware and software components of the computer platform illustrated in, e.g., FIGS. 10 and 11A. Laptop computer 100 includes a CPU 115A, digital memory 115B, display panel 102 and keyboard 115C. Other hardware capabilities may also be provided by laptop 100, such as network interface 115D, videoconferencing camera 115E and audio speakers 115F. Laptop 100 also includes software components such as operating system (OS) 116C and applications 116D, both implemented by inter alia CPU 115A. Similarly, smart removable display 104 includes CPU 114A, digital memory 114B and display panel 110, which implement software components such as operating system (OS) 114C and applications 114D. When docked in bay 101, smart removable display 104 may interact with laptop 100 via, e.g., power connector 106 and data connector 109, including implementing display 110 as a secondary display accessible by laptop OS 116C. Thus, when smart removable display 104 is docked, laptop 100 and its OS 116C may utilize both display panels 102 and 110 to implement a user interface. Whether docked in bay 101 or removed therefrom, smart removable display 104 may also be operable as an independent computing device, with CPU 114A implementing OS 114C and applications 114D. Thus, when docked and operating as an independent computing device, smart removable display 104 may enable a user to readily access its additional computing power and capabilities simultaneously with use of laptop 100 OS 116C and applications 116D in a manner that is ergonomic and convenient to the user.

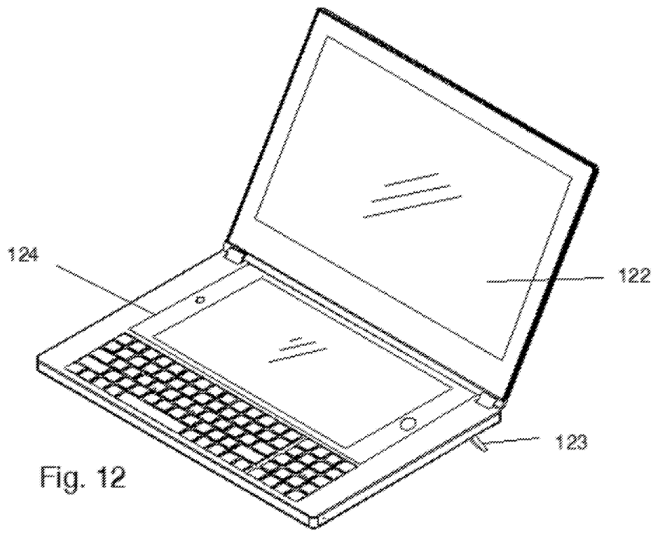

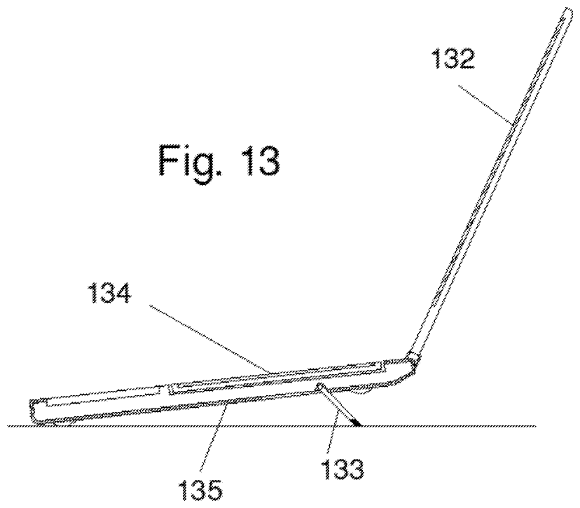

FIG. 12 shows that the lack of display panel adjustability of the embodiment of FIGS. 10 and 11A may be at least partly overcome by providing an incline mechanism 123 that improves the viewing angle and image quality for the tablet computer 124 by tilting the laptop base, as previously described in other embodiments. FIG. 13 is a cross-section of the laptop with a more detailed view of the incline mechanism.

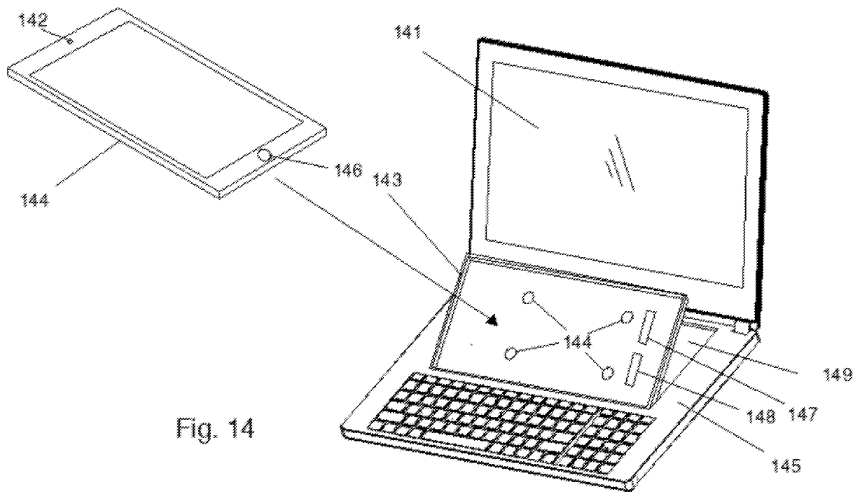

FIG. 14 is another embodiment of the invention with an additional improvement in angle adjustability for the smart display. The carrier shell 143 may be hinged about the laptop base (hinges not visible in FIG. 14 because of their location inside the laptop base) and the carrier shell 143 is designed to be able to receive, hold and carry the tablet computer 144. The carrier shell 143 is also equipped with connectors such as 147 and 148 to establish power and data transfer capability between the laptop and the tablet 144, and with magnets 144 to securely hold the tablet in position inside the shell. When not in use, the shell may be folded down into the laptop bay 149. Instead of the shell shown in FIG. 14, it is also possible to use a partial shell, or just a frame holding parts of the tablet, or some other rotational attachment method.

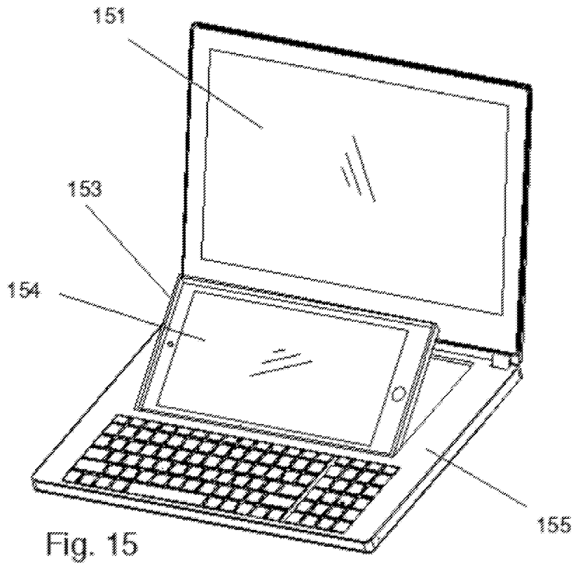

FIG. 15 show the embodiment of FIG. 14 with the tablet inserted into the carrier shell, operating as a smart second display panel for the laptop.

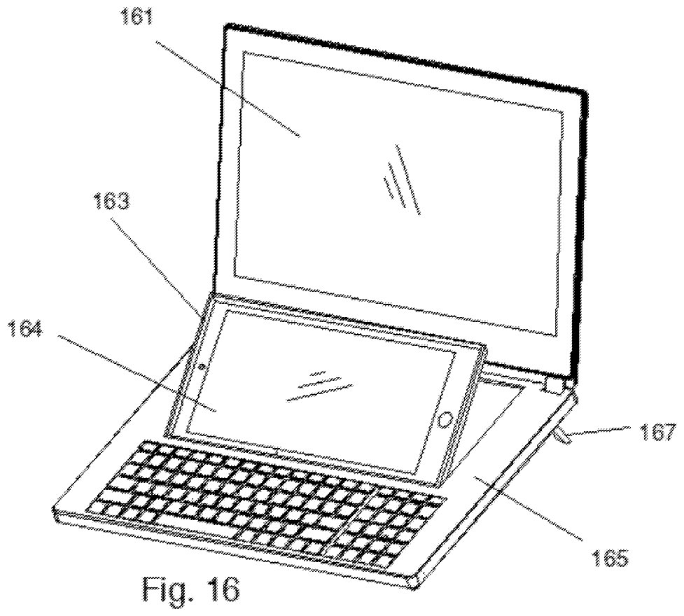

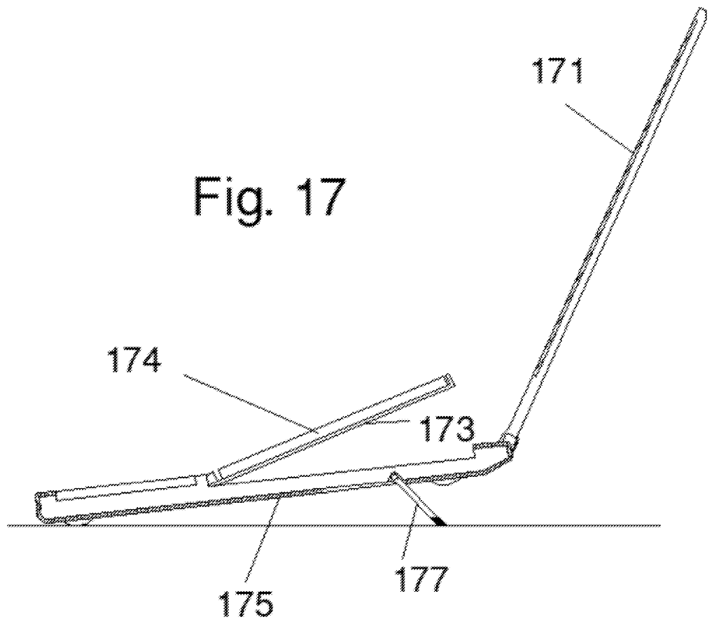

FIG. 16 shows that the image quality of the display panels may be even further improved and the potential for blockage of the view of the main display panel by the tablet may be reduced or avoided by providing an incline mechanism 167. FIG. 17 shows a cross-section of the laptop with details of a possible incline mechanism 177.

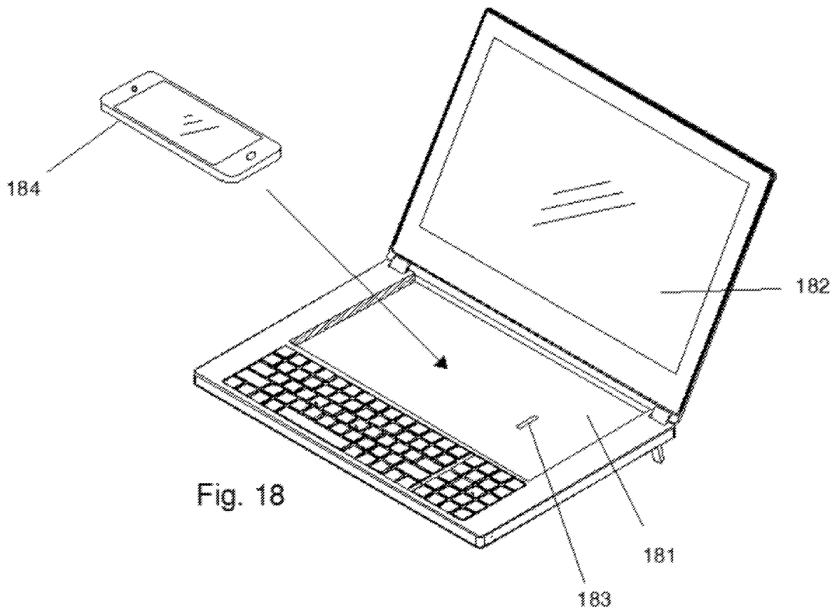

FIG. 18 shows another embodiment of this invention that also merges mobile computing and laptop computing. The laptop bay 181 may receive and hold a smart phone, such as an iPhone or an Android phone, and charge the phone, establish communication and sync phone with laptop through an optional connector 183. The phone may be held securely inside the bay through magnets or some mechanical engagement mechanism, in landscape or portrait orientation. Communication and syncing may also be done wirelessly, but a physical connection is usually faster, more reliable, safer and more secure. The phone display panel may also serve as the second display panel for the laptop, or the laptop display 182 may be used as a larger second display for the phone, which allows the user to operate the phone with the convenience of a larger display and the convenience and improved accuracy of the larger laptop keyboard. Alternatively, the phone 184 can also be held in place in a certain fixed or variable angle relative to the laptop surface by insertion of the phone in portrait or landscape orientation into a groove located on the laptop base, as previously illustrated in FIG. 7B.

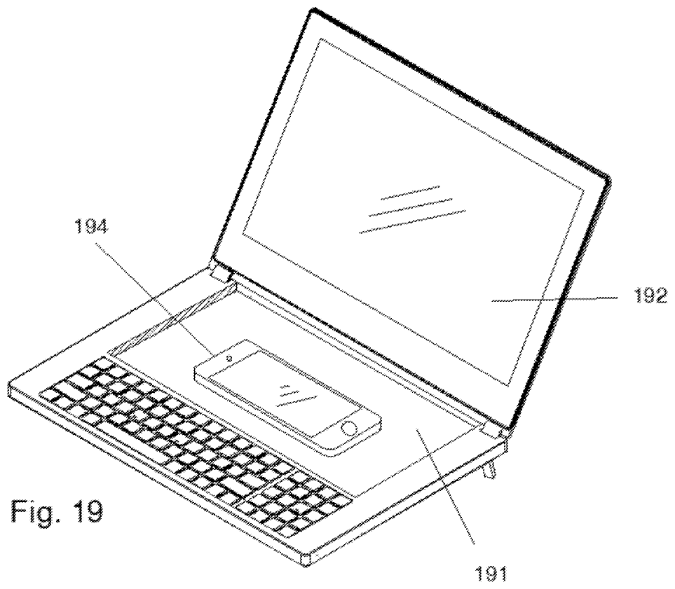

FIG. 19 shows the smartphone docked inside the laptop bay, serving as a second display panel for the laptop and working collaboratively with the laptop. The user may run his/her favorite smartphone apps, including social media, on the large laptop display, and also benefit from the use of the keyboard when using the phone with faster and more accurate typing input. The laptop may also greatly benefit from a wealth of mobile applications that now may also run on the laptop.

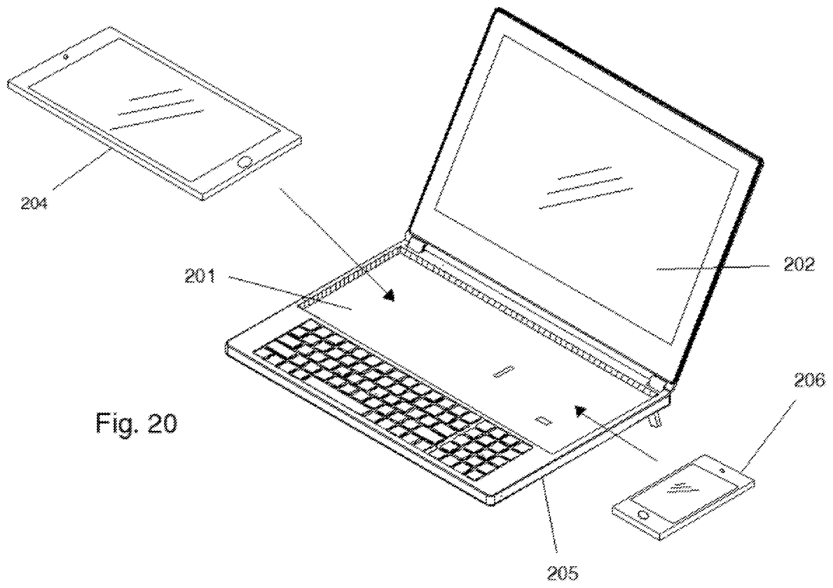

FIG. 20 shows a laptop that may simultaneously hold and interact with both a tablet and a smart phone. The bay 201 has interfaces for both the tablet and the smart phone.

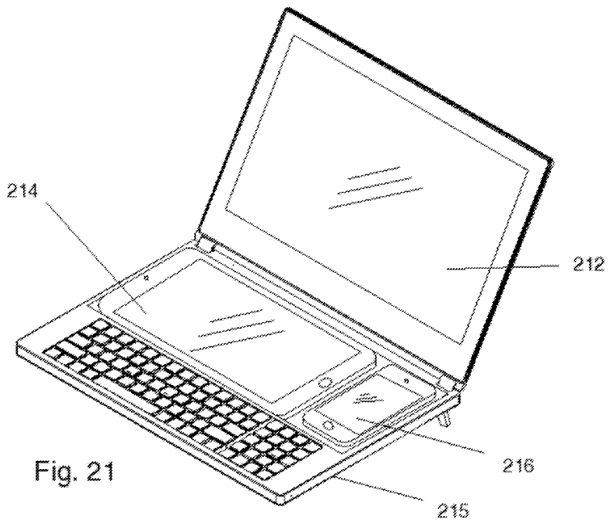

FIG. 21 shows one of the many possible layouts to integrate a laptop, tablet and smart phone in one command center for the user, forming a complete ecosystem that combines mobile and laptop computing. Base unit 215 is connected via hinges to display unit 212 in a clamshell configuration. Base unit 215 includes a dock configured to support (and preferably also retain) removable tablet 214 and mobile phone 216. For improved viewing quality, a tiltable shell or tray can be provided (as previously shown in FIG. 8 with shell 83), wherein the shell has the necessary connectors and holding features such as magnets or interlocking features to connect with and physically hold the tablet 214 and/or phone 216 at a desired angle relative to base unit 215. Alternatively, the tablet 214 and the phone 216 may be held in place in a certain fixed or variable angle relative to the laptop surface by insertion of the removable devices in portrait or landscape orientation into a groove located on the laptop base, as previously illustrated in FIG. 7B.

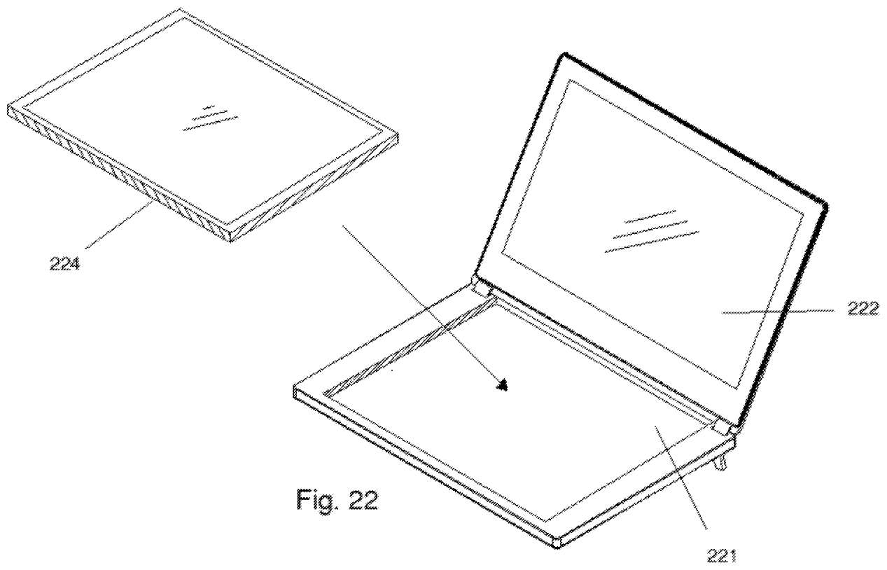

FIG. 22 shows a multi-display panel laptop wherein the second display 224 is a full-size display, meaning that the second display 224 occupies essentially all space available on the laptop base. This laptop does not have a physical keyboard and user input requires a virtual keyboard displayed on one of the two displays: secondary display 224 or fixed display 222. The second display 224 is also a removable display, which the user may insert into the laptop bay 221 to use the second display 224 as an additional display panel for laptop computing, or remove the secondary display 224 from the base to use the secondary display 224 for any other purpose, such as a large display for another device (another laptop or tablet computer, a smart phone, a gaming platform, a presentation display for an audience, or any other purpose). The laptop may also provide an incline mechanism to improve viewing angle and image quality on the secondary display 224. In an alternative embodiment, a carrier shell or frame or holding rotational structure may be provided in the laptop base that may pivot around the base to hold the removable secondary display 224 and adjust its viewing angle.

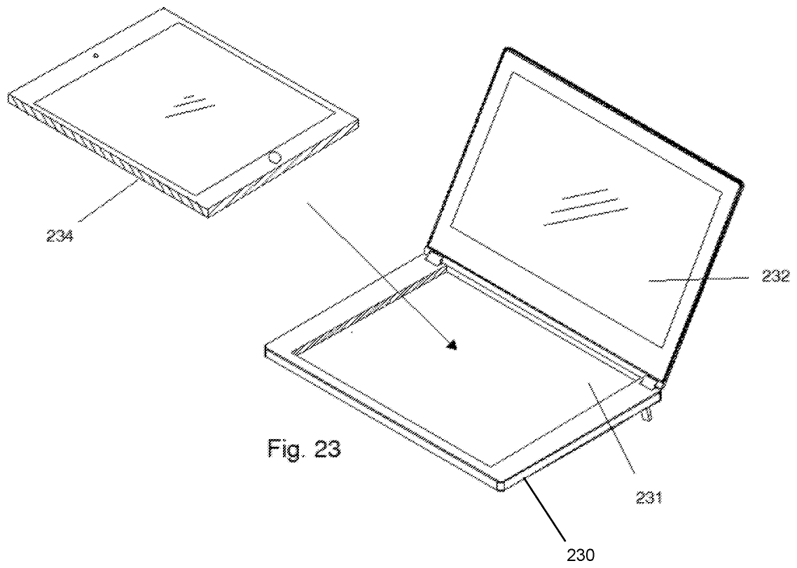

FIG. 23 shows another embodiment of the invention with a full-size smart display 234, such as a tablet computer or similar, used as the second display panel of the laptop (along with primary display unit 232) via removable insertion of smart display 234 into a receptacle 231 provided in the laptop base 230. Tablet 234 has a top surface area that is substantially similar to the top surface area of the laptop base 230. In some embodiments, smart display 234 may take up the entirety of the top surface of laptop base 230. In other embodiments, the top surface area of smart display 234 may be the majority, or even the substantial majority (e.g., in some embodiments, 80% or more), of the top surface area of laptop base 230. The many advantages and possibilities of a smart second display have already been mentioned in this specification. The tablet 234 allows a merger of mobile and laptop computing. For user input, a virtual keyboard on either display or an external physical keyboard (wired or wireless) may be used. An external physical keyboard can be dockable into the laptop's bay when the tablet (i.e. removable second display) is not in the docked state. The bay may be equipped with appropriate connectors to digitally connect with the external keyboard when the keyboard is inserted in to the bay, enabling the external keyboard to interact with the laptop operating system as a wired accessory thereof; in some embodiments, the same connector utilized for digital communications with a docked removable second display may be accessible to the external keyboard (e.g. connector 109). If the external keyboard is of the wireless type, the bay does not need provide such digital connectors and the bay would provide just the function of physically holding the keyboard in place for user convenience; however, in such embodiments, the external keyboard could optionally interface with a power connector provided within the laptop bay (e.g. connector 106) thereby allowing the wireless keyboard to recharge an internal battery when docked.

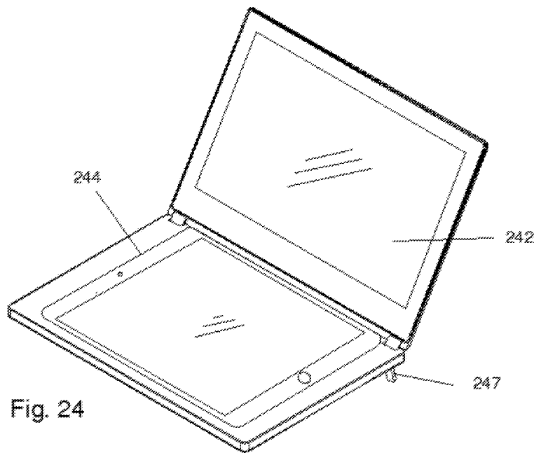

FIG. 24 shows the embodiment of FIG. 23 with the tablet 244 inserted into the laptop bay, serving as the laptop's second full-size display. The incline mechanism 247 may be used to provide angle adjustability to the tablet and enhance image quality.

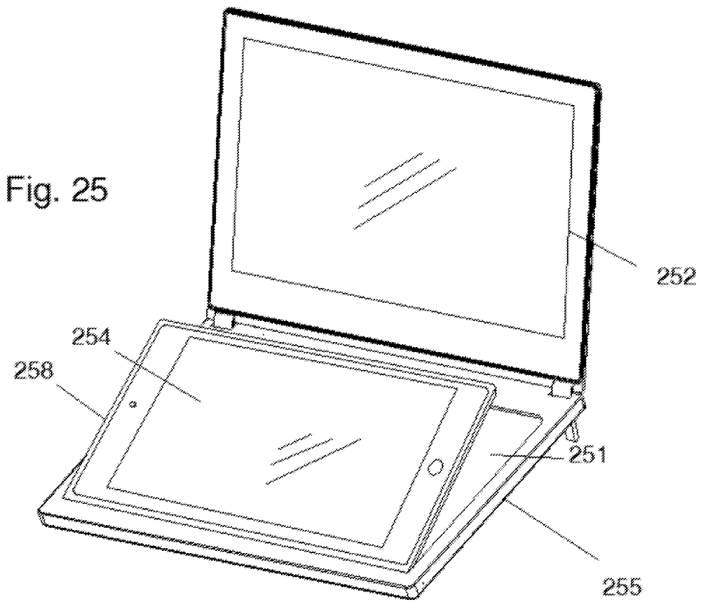

FIG. 25 shows another embodiment of the invention with a full-size smart second display 254 wherein a carrier shell 258 or similar structure is hinged on the laptop base 255, enabling the user to vary the viewing angle of the tablet 254 by rotating the shell about the base 255. When not in use, the tablet may be folded down into the laptop bay 251. This same concept can be applied to a smart phone, in landscape or portrait mode or both modes.

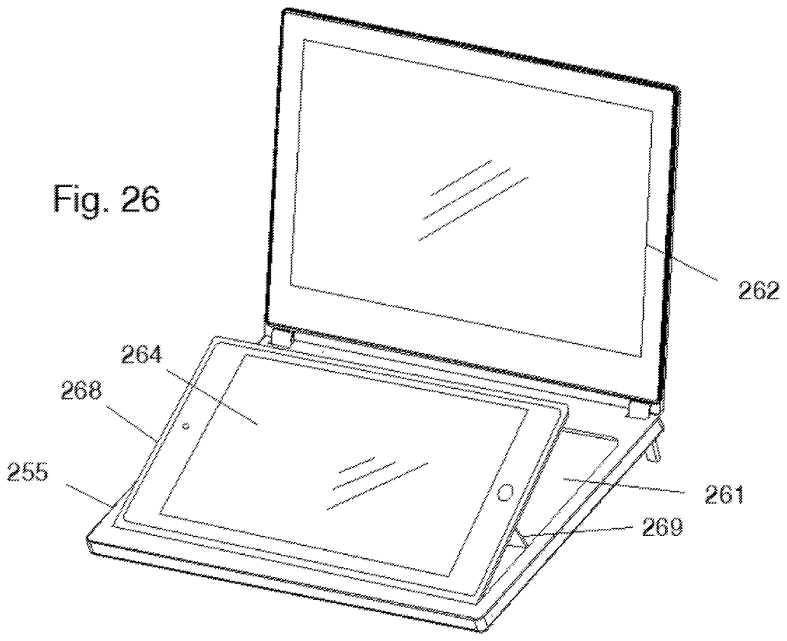

FIG. 26 shows a similar embodiment to FIG. 25, with an additional feature consisting of a deployable back support structure 269 for a removable tablet 268, which may be shaped like one or more tabs or beams that for instance may be extended out from the back of tablet 268 to rest in the bay 261, and folded back in against a back surface of tablet 268 to enable storage of tablet 268 in bay 261. Bay 261 may have mating small indentations to stabilize tablet 268 when support structure 269 is extended, and to prevent support structure 269 from slipping. This feature is especially important for using the tablet's touch display panel 264 and avoiding oscillation and movement of the tablet 268 when the user touches the tablet display 264 for input with a finger or with a stylus. It is contemplated and understood that in some embodiments, support structure 269 may deploy directly from a rear surface of tablet 268; while in other embodiments, tablet 268 may be retained within a carrier shell (as described elsewhere herein) with support structure 269 extended from a back surface of the carrier shell to engage against bay 261 and support the carrier shell/tablet combination at an angle relative to base unit 255.

The multi-display panel laptop embodiments shown herein, which are able to receive, hold and connect with a tablet computer and/or a smart phone in the laptop's bay and intelligently interact with them, enables the convergence of laptop computing with mobile computing, which until now have been largely segregated from each other. This convergence creates an integrated ecosystem where the laptop, phone and tablet can work cooperatively and intelligently with each other to combine the power, speed and storage capacity of a laptop with the rich applications world, social media and convenience of the mobile world.

In addition, this convergence can be further facilitated and enhanced by providing devices with the ability to interact with other operating systems. For instance, an iPhone that can be docked into the bay of a Windows multi-display panel laptop, such as in the manner illustrated in FIG. 11B, and easily connect with the laptop (e.g. via software drivers implemented within OS 116C and OS 114C enabling exchange of data via, e.g., connector 109 and/or wireless communication interfaces), would be a great advantage for smart phone users by making information, apps and data available to both the phone and the laptop. Similarly, for example an Android tablet that can be docked into a Mac laptop and intelligently interact with the laptop in a similar manner would be very advantageous for both the laptop owner and the tablet owner. Therefore, to maximize portability and convergence of mobile and laptop technologies, embodiments of this invention include devices compatible with multiple operating systems.

In some embodiments, multi-operating system compatibility can be achieved by installing multiple Operating Systems in the same device, such as installing Windows in a Mac laptop, or installing an Apple Mac Operating System in a Windows computer. (For example, in the context of FIG. 11B, laptop 100 may implement both OS 116C and a second OS both using CPU 115A.) At the time of booting the laptop, the user can choose what Operating System will be used for that session. This approach will be referred to herein as Dual or Multiple Operating Systems, and it basically entails two or more Operating Systems coexisting simultaneously in the device (laptop or smartphone), with the user choosing which one gets activated while the others remain dormant.

An alternative to the Dual or Multiple Operating System approach is to have a primary Operating System in the device and additionally some emulator software (a virtual machine) that can emulate an additional Operating System in the device, which basically runs on top of the primary Operating System when activated. The device can be any smart device such as a laptop computer or a smart phone or a tablet and others.

Some embodiments of the multidisplay panel laptop of this invention can be configured to be compatible with multiple Operating Systems, so that the user can dock into it devices running different Operating Systems. For instance, the multidisplay panel laptop can be a Windows laptop which is configured to be also compatible with Android and Apple IOS, enabling the user to dock an iPhone, an iPad, an Android phone or an Android tablet, or a Windows phone, into the laptop. Such compatibility can be achieved by installing Dual or Multiple Operating Systems in the multidisplay panel laptop, or by running a virtual machine (emulation software) on the multi-display panel laptop of this invention.

In addition, smart devices like tablets and smart phones can also be configured to be compatible with multiple Operating Systems, making it possible to dock them into multidisplay laptops operating under different Operating Systems.

In some embodiments, hardware components of the laptop computer may be made available to an operating system and software applications implemented by the second, removable display. For example, in the context of the embodiment of FIG. 11B, when smart removable display 104 is docked within bay 101 of laptop 100, mobile OS 114C and mobile apps 114D may transmit display content to display 102 (e.g. via data connector 109), whether mirroring the content of display 110 or extending the display available to OS 114C. Likewise, other hardware components of laptop 100 may be made available to smart removable display 104, such as keyboard 115C, a network interface 115D, an integrated videoconferencing camera 115E, speakers 115F, or the like. In this way, when smart removable display 104 is docked within laptop 100, OS 114C and applications 114D may be operated by a user, while providing the user with use of enhanced hardware capabilities of the larger form-factor laptop 100.

The above disclosures and descriptions are exemplary in nature, and not intended to limit the scope of the invention. Any person skilled in the art given the present disclosures could design variations and additional embodiments of the same invention based on these disclosures, which are all covered by this application for letters patent.

Although some of various drawings illustrate a number of logical stages in a particular order, stages which are not order dependent may be reordered and other stages may be combined or broken out. Alternative orderings and groupings, whether described above or not, may be appropriate or obvious to those of ordinary skill in the art of computer science. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to be limiting to the precise forms disclosed. Many modifications and variations are possible in view of the above teachings. The embodiments were chosen and described in order to best explain the principles of the aspects and its practical applications, to thereby enable others skilled in the art to best utilize the aspects and various embodiments with various modifications as are suited to the particular use contemplated.

What is claimed:

1. A multi-display laptop computer comprising:
a central processing unit (CPU) implementing an operating system (OS);
digital memory;
a first display unit rotatably attached to a laptop computer base via one or more hinges; and
a second, detachable display unit which can be attached by the user to the laptop base (docked state) or detached by the user from the laptop base (detached state);
wherein the laptop OS implements a user interface using both the first display unit and the second display unit when the second display unit is in the docked state;
wherein the laptop OS implements a user interface using the first display unit but not the second display unit, when the second display unit is in the detached state; and
wherein the second display unit is equipped with its own CPU, digital memory and power source, such that it is independently operable as a standalone mobile computing device when in the detached state.

2. The multi-display laptop computer of claim 1, wherein the laptop base comprises:
a bay to receive and securely house the detachable display unit in the docked state;
a holding component configured to hold the second display unit inside the bay when in the docked state;
connectors in the laptop base that mate with the second display unit when the second display unit is inserted into the laptop's bay, whereby the laptop computer can charge the second display unit and transmit data between the laptop computer and the second display unit while in the docked state.

3. The multi-display laptop computer of claim 2, in which the holding component comprises one or more magnets.

4. The multi-display laptop computer of claim 2, in which the holding component comprises an interlocking mechanism within the bay and a mating interlocking mechanism on the second display unit.

5. The multi-display laptop computer of claim 1, wherein the laptop base comprises a groove open towards a top surface of the laptop base, to receive and hold the second display unit at an angle inclined relative to the laptop base when in the docked state.

6. The multi-display laptop computer of claim 5, wherein the groove is fixed in position relative to the laptop base.

7. The multi-display laptop computer of claim 5, in which the groove comprises a pivotable hinged receptacle, whereby the angle of the second display unit may be varied by the user.

8. The multi-display laptop computer of claim 5, further comprising a holding component within the groove operable to removably secure the second display unit in a docked state.

9. The multi-display laptop computer of claim 8, in which the holding component comprises one or more magnets.

10. The multi-display laptop computer of claim 8, in which the holding component comprises one or more interlocking mechanisms.

11. The multi-display laptop computer of claim 5, in which the groove contains one or more connectors to establish communication between the laptop and the removable device.

12. The multi-display laptop computer of claim 1, in which the laptop base further comprises a rotatable shell in which the second display unit may be received and held while in the docked state, whereby a user may adjust the viewing angle of the second display unit while in said docked state.

13. The multi-display laptop computer of claim 1, further comprising an incline mechanism to tilt the laptop base relative to a surface on which the laptop base rests, and thus adjust a viewing angle of the second display unit.

14. The multi-display laptop computer of claim 1, wherein the second, detachable display unit comprises a tablet computer.

15. The multi-display laptop computer of claim 1, wherein the second, detachable display unit comprises a smartphone.

16. The multi-display panel laptop computer of claim 14, in which the laptop base comprises a bay, a groove or other feature to receive and securely house the tablet computer when in a docked state; the bay, groove or feature further configured to receive and support a smartphone.

17. The multi-display laptop computer of claim 1, wherein the second, detachable display unit is a tablet computer that, when in the docked state, occupies a majority of the top surface area of the laptop base.

18. The multi-display laptop computer of claim 17, in which the tablet computer CPU implements software configured to interact with at least a second laptop computer when in a state docked therewith, the second laptop computer implementing an operating system different from that implemented by said multi-display laptop computer.

19. The smart phone of claim 16, in which the smartphone comprises a CPU implementing software configured to interact with at least a second laptop computer when in a state docked therewith, the second laptop computer implementing an operating system different from that implemented by said multi-display laptop computer.

20. The multi-display laptop computer of claim 17, wherein the laptop computer does not have a physical built-in keyboard; and wherein the laptop computer receives keyboard input either via a virtual keyboard implemented by the tablet computer when in a docked state, or via an external keyboard removably dockable into the bay when the tablet computer is not in a docked state.
